(19) United States
(12) Patent Application Publication
(10) Pub. No.: US 2022/0290576 A1
(43) Pub. Date: Sep. 15, 2022

(54) AIRCRAFT PROPULSION SYSTEM

(71) Applicant: HONDA MOTOR CO., LTD., Tokyo (JP)

(72) Inventor: Akira Ota, Wako-shi (JP)

(21) Appl. No.: 17/672,767

(22) Filed: Feb. 16, 2022

(30) Foreign Application Priority Data
Mar. 12, 2021 (JP) 2021-040377

(51) Int. Cl. F01D 15/10; B64D 27/24; B64D 27/10

(52) U.S. Cl. CPC F01D 15/10; B64D 27/24; B64D 27/10; B64D 2027/026

(57) ABSTRACT

An aircraft propulsion system includes: a gas turbine engine attached to an airframe of an aircraft; a generator connected to an engine shaft of the engine; a first electric motor driven using electric power including electric power generated by the generator; a rotor attached to the airframe of the aircraft and driven using a driving force output by the first electric motor; and a control device configured to control an operating state of the engine. The control device includes a flow rate controller which reduces the flow rate of fuel supplied to the engine so that the engine does not misfire when a decrease in output of the engine is promoted using a driving force output by a second electric motor included in the generator, and a drive controller which controls the magnitude of the driving force output by the second electric motor so that the temperature of the engine does not exceed an allowable temperature.

### CROSS-REFERENCE TO RELATED APPLICATION

Priority is claimed on Japanese Patent Application No. 2021-040377, filed Mar. 12, 2021, the content of which is incorporated herein by reference.

### BACKGROUND

### Field of the Invention

The present invention relates to an aircraft propulsion system.

### Description of Related Art

In the related art, there is an aircraft engine hybrid propulsion device composed of a gas turbine engine, a generator, a battery, and a motor (the specification of U.S. Pat. No. 8,727,271). Generally, in the operation of such an aircraft engine hybrid propulsion device, although it is possible to shift a takeoff mode in which a high load is applied to an engine to a cruise mode in which a low load is applied to the engine, at that time, rapidly reducing an engine output is required from the viewpoint of fuel efficiency, thrust, operability associated with battery charging, and the like.

### SUMMARY

However, when the engine output is reduced, there is a concern concerning an engine misfire if an amount of fuel supply is not appropriately controlled. If the engine output is slowly reduced in an attempt to prevent an engine misfire, fuel will be wasted accordingly. For this reason, in the related art, there is a case in which it is not possible to rapidly reduce an engine output while preventing an engine misfire.

The present invention was made in consideration of such circumstances, and an object of the present invention is to provide an aircraft propulsion system capable of rapidly reducing an engine output while preventing an engine misfire in a gas turbine engine.

The aircraft propulsion system according to the present invention has the following constitution.

(1): An aircraft propulsion system according to an aspect of the present invention includes: a gas turbine engine attached to an airframe of an aircraft; a generator connected to an engine shaft of the gas turbine engine; a first electric motor driven using electric power including electric power generated by the generator; a rotor attached to the airframe of the aircraft and driven using a driving force output by the first electric motor; and a control device configured to control an operating state of the gas turbine engine, wherein the control device includes a storage device configured to store a program, and a hardware processor, and the hardware processor, by executing the program stored in the storage device, performs flow rate control processing which reduces the flow rate of fuel supplied to the gas turbine engine so that the gas turbine engine does not misfire when a decrease in output of the gas turbine engine is promoted using a driving force output by a second electric motor included in the generator, and performs drive control processing which controls the magnitude of the driving force output by the second electric motor so that the temperature of the gas turbine engine does not exceed an allowable temperature when the driving force output by the second electric motor promotes a decrease in output of the gas turbine engine.

(2): In the aspect of the above (1), the hardware processor may stop a reduction in flow rate of the fuel and keep the flow rate of the fuel constant when the flow rate of the fuel has reached a misfire line indicating a lower limit of the flow rate range in which the gas turbine engine does not misfire in the flow rate control processing.

(3): In the aspect of the above (1), the hardware processor may control the magnitude of the driving force output by the second electric motor so that the temperature of the gas turbine engine runs along an overtemperature line when the temperature of the gas turbine engine has reached the overtemperature line indicating an upper limit of the temperature range in which the gas turbine engine is not in an overtemperature state in the drive control processing.

(4): In the aspect of the above (1), the hardware processor may control the magnitude of the driving force output by the second electric motor so that the temperature of the gas turbine engine is a temperature within a range from an overtemperature line to a lower limit temperature line indicating a temperature lower than the overtemperature line by a prescribed temperature when the temperature of the gas turbine engine has reached the overtemperature line indicating an upper limit of a temperature range in which the gas turbine engine is not in an overtemperature state in the drive control processing.
(5): In the aspect of the above (1), the hardware processor may operate the flow rate control processing and the drive control processing in parallel when promoting a decrease in output of the gas turbine engine using the driving force output by the second electric motor.

According to (1) to (5), it is possible to rapidly reduce an output of an gas turbine engine while preventing an engine misfire through an aircraft propulsion system including: the gas turbine engine attached to an airframe of an aircraft; a generator connected to an engine shaft of the gas turbine engine; a first electric motor driven using electric power including electric power generated by the generator; a rotor attached to the airframe of the aircraft and driven using a driving force output by the first electric motor; and a control device configured to control an operating state of the gas turbine engine, wherein the control device includes a flow rate controller which reduces the flow rate of fuel supplied to the gas turbine engine so that the gas turbine engine does not misfire when a decrease in output of the gas turbine engine is promoted using a driving force output by a second electric motor included in the generator, and a drive controller which controls the magnitude of the driving force output by the second electric motor so that the temperature of the gas turbine engine does not exceed an allowable temperature when the driving force output by the second electric motor promotes a decrease in output of the gas turbine engine.

### BRIEF DESCRIPTION OF THE DRAWINGS

FIG. 1 is a diagram showing an example of a constitution of an aircraft propulsion system according to an embodiment.

FIG. 2 is a block diagram showing an example of a functional constitution of a control device in the embodiment.

FIG. 3 is a diagram showing an example of a relationship between the number of rotations of a gas turbine (GT) engine and the flow rate of fuel supplied to the GT engine.

FIG. 4 is a diagram showing an example of a relationship between the number of rotations of the GT engine and the temperature of the GT engine.

FIG. 5 is a flowchart showing a first example of a flow of processing in which a control device controls a fuel pump and a second electric motor when the GT engine is decelerated with a deceleration assist using the second electric motor.

FIG. 6 is a flowchart showing a second example of a flow of processing in which the control device controls the fuel pump and the second electric motor when the GT engine is decelerated with the deceleration assist using the second electric motor.

### DESCRIPTION OF EMBODIMENTS

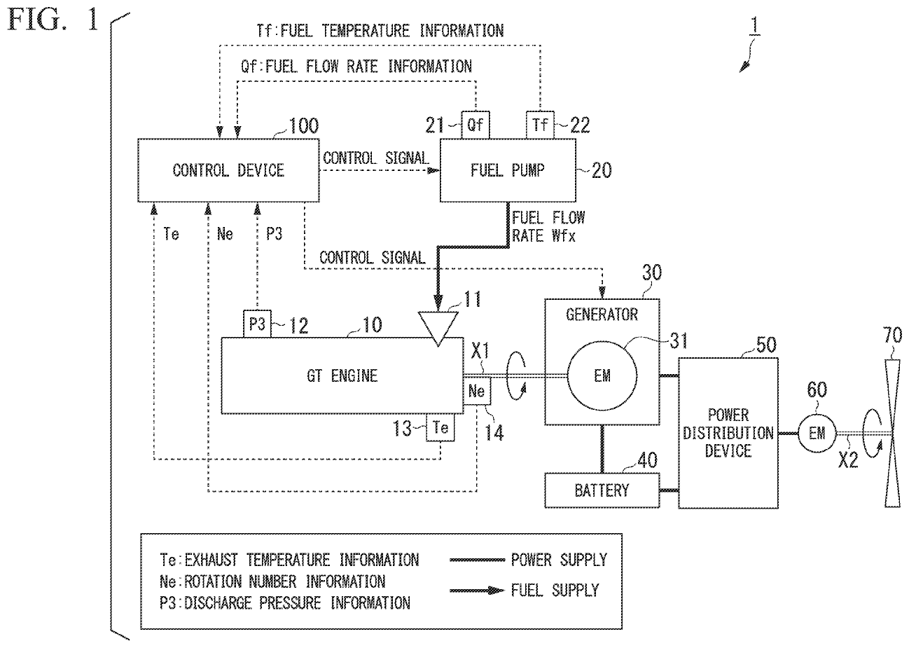

An aircraft propulsion system according to the present invention will be described below with reference to the drawings. As used throughout this disclosure, the singular forms “a,” “an,” and “the” include plural reference unless the context clearly dictates otherwise. FIG. 1 is a diagram showing an example of a constitution of an aircraft propulsion system 1 according to an embodiment. The aircraft propulsion system 1 includes, for example, a gas turbine engine (GT engine) 10, a fuel pump 20, a generator 30, a battery 40, a power distribution device 50, a motor 60, a rotor 70, and a control device 100.

The GT engine 10 includes, for example, an intake port (not shown), a compressor, a combustion chamber, a turbine, and the like. The compressor compresses intake air suctioned through the intake port. The combustion chamber is located downstream of the compressor and a gas obtained by mixing the compressed air with fuel is burned to generate combustion gas in the combustion chamber. The turbine is connected to the compressor and rotates integrally with the compressor using the power of the combustion gas. The rotation of an output shaft X1 of the turbine causes the generator 30 connected to the output shaft X1 of the turbine to operate. The generator 30 includes a motor 31 and generates electricity by driving the motor 31 using a rotational force transmitted via the output shaft X1. The generator 30 supplies electric power generated by the generator 30 itself to the battery 40 and the power distribution device 50. The battery 40 has a storage battery therein and charges the storage battery with the electric power supplied from the generator 30. The battery 40 supplies the electric power accumulated through the charging to the power distribution device 50. The power distribution device 50 supplies the electric power accumulated in the battery 40 to the motor 31 of the generator 30 and the motor 60. The motor 60 rotates an output shaft X2 when operating using the electric power supplied from the power distribution device 50. The rotation of the output shaft X2 of the motor 60 causes the rotor 70 connected to the output shaft X2 of the motor 60 to rotate. An aircraft having the aircraft propulsion system 1 installed therein flies using a propulsive force generated due to the rotation of the rotor 70. Here, the motor 60 is an example of a “first electric motor” and the motor 31 is an example of a “second electric motor.”

The motor 31 can generate torque (hereinafter referred to a “load torque”) in a rotation direction opposite to a rotation direction of torque (hereinafter referred to as an “engine torque”) transmitted through the output shaft X1 of the turbine under the control of the control device 100. The motor 31 operates using the electric power supplied from the battery 40 and applies a load torque to the output shaft X1. With such a constitution, the motor 31 can apply a load torque to an engine torque to promote (hereinafter also referred to as “assist”) a decrease in output of the GT engine 10. Decreasing an output of the GT engine 10 means reducing a moving speed of the aircraft having the aircraft propulsion system 1 installed therein. Thus, in the following, reducing the output of the GT engine 10 may be simply referred to as “decelerating the GT engine 10” in some cases.

A fuel nozzle 11 is attached to the GT engine 10. The fuel nozzle 11 is connected to the fuel pump 20 and supplies the fuel discharged by the fuel pump 20 to the GT engine 10. The fuel pump 20 is connected to a fuel tank (not shown) and supplies the fuel accumulated in the fuel tank to the GT engine 10. The flow rate of fuel discharged by the fuel pump 20 (hereinafter also referred to as a “fuel flow rate”) is controlled by the control device 100. The fuel pump 20 includes a flow rate sensor 21 configured to measure a flow rate Qf (volume flow rate) of the fuel discharged by the fuel pump 20 itself and a temperature sensor 22 configured to measure a temperature Tf of the fuel discharged by the fuel pump 20 itself. The fuel pump 20 supplies fuel flow rate information indicating a value of the fuel flow rate measured by the flow rate sensor 21 and fuel temperature information indicating a value of the fuel temperature measured by the temperature sensor 22 to the control device 100.

The GT engine 10 includes a pressure sensor 12 configured to measure a discharge pressure P3 of the compressor, a temperature sensor 13 configured to measure an exhaust temperature Te, and a number of rotations sensor 14 configured to measure the number of rotations Ne of the engine. The GT engine 10 supplies discharge pressure information indicating a value of the discharge pressure measured by the pressure sensor 12, exhaust temperature information indicating a value of the exhaust temperature measured by the temperature sensor 13, and rotation number information indicating the number of rotations of the engine measured by the number of rotations sensor 14 to the control device 100. The control device 100 generates and outputs control information indicating an amount of operation to be provided to the fuel pump 20 and the motor 31 based on the information such as the fuel flow rate information, the fuel temperature information, the discharge pressure information, the exhaust temperature information, and the rotation number information supplied from the GT engine 10 and the fuel pump 20.

The control device 100 in the embodiment controls the magnitude of a load torque output by the motor 31 so that the temperature of the engine does not exceed an allowable temperature while reducing the flow rate of fuel supplied to the engine so that the engine does not misfire when an output of the GT engine 10 is reduced due to the assistance of the motor 31 in the aircraft propulsion system 1 constituted as described above.

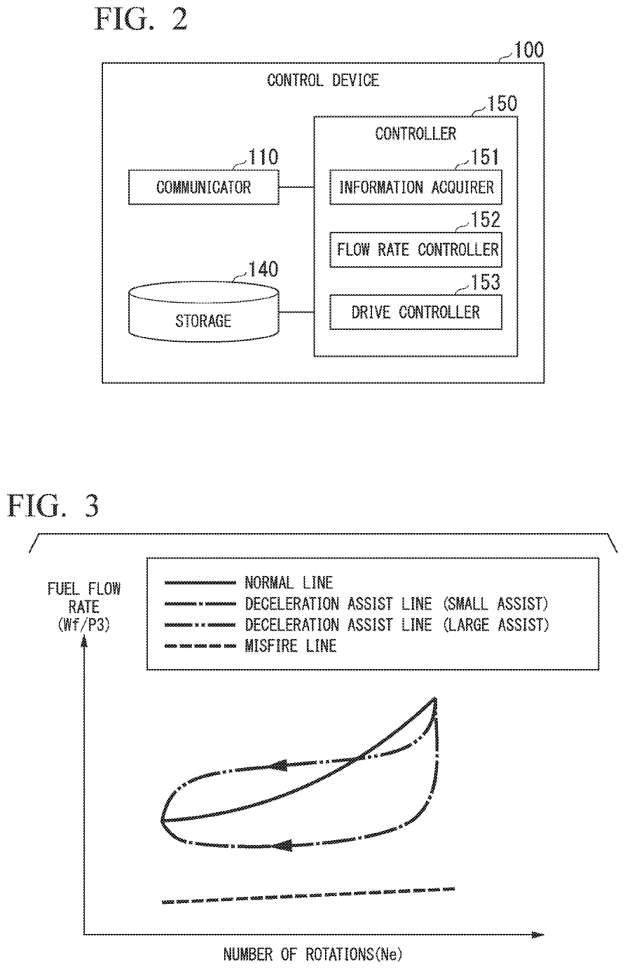

FIG. 2 is a block diagram showing an example of a functional constitution of the control device 100 in the embodiment. The control device 100 includes a communicator 110, a storage 140, and a controller 150.

The communicator 110 is a communication interface configured to connect the control device 100 to a control network in the aircraft. The communicator 110 communicates with the pressure sensor 12, the temperature sensor 13, the number of rotations sensor 14, the fuel pump 20, the flow rate sensor 21, the temperature sensor 22, the generator 30, and the power distribution device 50 via the control network in the aircraft.

The storage 140 is realized using, for example, a hard disk drive (HDD), a flash memory, an electrically erasable programmable read only memory (EEPROM), a read only memory (ROM), a random access memory (RAM), or the like. The storage 140 stores various programs such as firmware and application programs. The storage 140 stores the fuel temperature information, the fuel flow rate information, the exhaust temperature information, the rotation number information, the discharge pressure information, and the like which are acquired from the outside, in addition to a program as a reference for a processor.

The controller 150 is realized by executing a program (software) by a hardware processor such as a central processing unit (CPU). The controller 150 includes, for example, an information acquirer 151, a flow rate controller 152, and a drive controller 153. Some or all of the constituent elements of the controller 150 may be realized using hardware (circuit part: including a circuitry) such as a large scale integration (LSI), an application specific integrated circuit (ASIC), a field-programmable gate array (FPGA), and a graphics processing unit (GPU) or may be realized by the cooperation of software and hardware. The program may be stored in advance in a storage device (a storage device including a non-transitory storage medium) such as a hard disk drive (HDD) or a flash memory, or may be stored in a removable storage medium (non-transitory storage medium) such as a digital versatile disc (DVD) or a compact disc (CD)-ROM and installed when the storage medium is installed in a drive device.

The information acquirer 151 communicates with the pressure sensor 12, the temperature sensor 13, the number of rotations sensor 14, the flow rate sensor 21, and the temperature sensor 22 via the communicator 110 to acquire the fuel temperature information, the fuel flow rate information, the exhaust temperature information, the rotation number information, and the discharge pressure information from these sensors. The information acquirer 151 stores these pieces of acquired information in the storage 140.

The flow rate controller 152 controls the flow rate of fuel supplied to the GT engine 10 using the fuel pump 20. Furthermore, when a load torque output by the motor 31 promotes a decrease in output of the GT engine 10 (that is, when the GT engine 10 is decelerated), the flow rate controller 152 reduces the flow rate of fuel supplied to the GT engine 10 by reducing an amount by an extent that the GT engine 10 does not misfire.

FIG. 3 is a diagram showing an example of a relationship between the number of rotations of the GT engine 10 and the flow rate of fuel supplied to the GT engine 10. In FIG. 3, the horizontal axis of a graph represents the number of rotations of the engine and the vertical axis thereof represents a fuel flow rate. A “normal line” in the drawing represents the relationship between the number of rotations of the engine and the fuel flow rate when the GT engine 10 is decelerated without performing deceleration assist using the motor 31 (that is, when the GT engine 10 is decelerated only by reducing the fuel flow rate). A “deceleration assist line (small assist)” and a “deceleration assist line (large assist)” in the drawing represent the relationship between the number of rotations of the engine and the fuel flow rate when a change in the number of rotations that is the same as the normal line is realized while performing deceleration assist using the motor 31. As can be seen from the drawing, when the deceleration assist using the motor 31 increases, it is possible to decelerate the GT engine 10 at a smaller fuel flow rate.

Here, a “misfire line” represents the relationship between the number of rotations of the engine and the fuel flow rate when the GT engine 10 misfires at a fuel flow rate lower than the misfire line. In other words, the misfire line can be said to be a line indicating a lower limit of a fuel flow rate range in which the GT engine 10 does not misfire. If the fuel flow rate falls below the misfire line and the GT engine 10 misfires, the engine needs to be ignited again. Thus, the control becomes complicated, which is not preferable. Once the engine misfires in an aircraft in air, it is dangerous if the engine cannot be ignited again due to some trouble. As is clear from the drawing, when the GT engine 10 is decelerated using the deceleration assist of the motor 31, the fuel flow rate decreases in a shorter time than that of the normal line. For this reason, when the GT engine 10 is decelerated with the deceleration assist using the motor 31, the flow rate controller 152 reduces the fuel flow rate so that the fuel flow rate does not fall below the misfire line.

In FIG. 3, although the vertical axis represents a fuel flow rate Wf (mass flow rate) divided by the discharge pressure P3, this is a measure for setting the misfire line to have a value which does not change significantly depending on the number of rotations and is performed to make it easier to understand that the misfire line is a lower limit of a control range of the fuel flow rate. For this reason, FIG. 3 does not necessarily show that the misfire line needs to be managed using a value of Wf/P3. In this case, the flow rate controller 152 can calculate a mass flow rate Wf based on a fuel temperature Tf and a volume flow rate Qf.

Referring to FIG. 2 again, the drive controller 153 will be described below. The drive controller 153 controls the magnitude of a load torque output by the motor 31 by outputting a control signal to the generator 30. Furthermore, the drive controller 153 controls the magnitude of the load torque output by the motor 31 so that the temperature of the GT engine 10 does not exceed an allowable temperature when the GT engine 10 is decelerated by the load torque output by the motor 31.

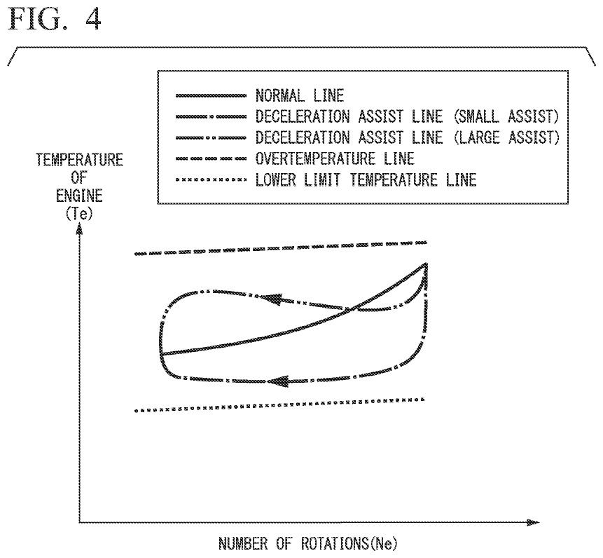

FIG. 4 is a diagram showing an example of a relationship between the number of rotations of the GT engine 10 and the temperature of the GT engine 10. In FIG. 4, the horizontal axis of the graph represents the number of rotations of the engine and the vertical axis represents the exhaust temperature Te of the GT engine 10 as the temperature of the GT engine 10. The “normal line” in FIG. 4 represents the relationship between the number of rotations of the engine and the temperature of the engine when the “normal line” in FIG. 3 is observed. Similarly, the “deceleration assist line (small assist)” in FIG. 4 represents the relationship between the number of rotations of the engine and the temperature of the engine when the “deceleration assist line (small assist)” in FIG. 3 is observed. Similarly, the “deceleration assist line (large assist)” in FIG. 4 represents the relationship between the number of rotations of the engine and the temperature of the engine when the “deceleration assist line (large assist)” in FIG. 3 is observed. It can be seen from FIG. 4 that, when the GT engine 10 is decelerated, the temperature of the engine rises when the deceleration assist using the motor 31 increases.

The “overtemperature line” in FIG. 4 is a line indicating a lower limit of a temperature range in which the GT engine 10 is not in an overtemperature state. The overtemperature line is to be determined in advance based on the durability of the GT engine 10. When the GT engine 10 is decelerated with the deceleration assist using the motor 31, the drive controller 153 controls the number of rotations of the GT engine 10 so that the temperature of the engine does not exceed the overtemperature line. To be specific, the drive controller 153 adjusts the number of rotations of the GT engine 10 by changing the load torque output by the motor 31.

Even if the temperature of the engine is controlled not to exceed the overtemperature line, on the other hand, if the temperature of the engine becomes too low, an engine misfire is likely to occur. Thus, in order to minimize the occurrence of such an engine misfire, the drive controller 153 may be constituted to control the number of rotations so that the temperature of the engine falls between the overtemperature line and a “lower limit temperature line” indicating a temperature lower than the overtemperature line by a prescribed temperature. In this case, the lower limit temperature line may be arbitrarily set within a range in which the temperature of the engine does not exceed the overtemperature line and does not cause an engine misfire.

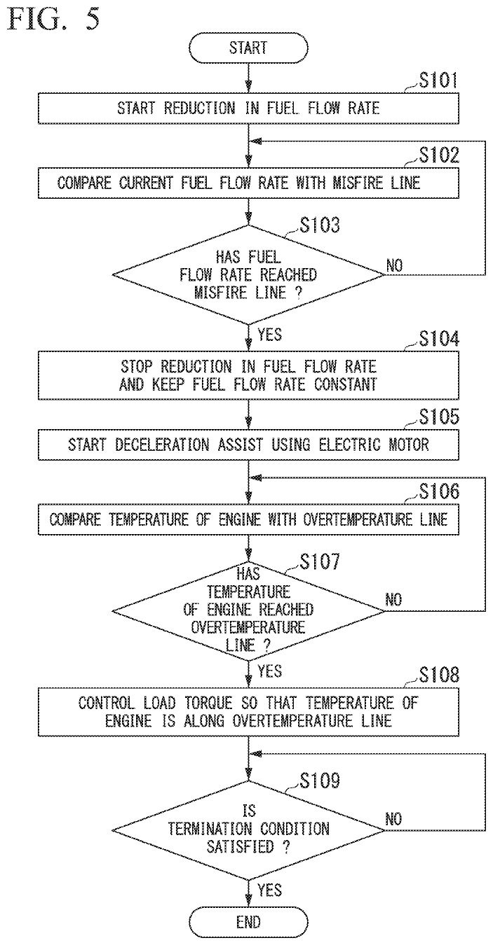

FIG. 5 is a flowchart for describing a first example of a flow of processing in which the control device 100 controls the fuel pump 20 and the motor 31 when the GT engine 10 is decelerated with the deceleration assist using the motor 31. First, in the control device 100, in response of an input of a deceleration instruction of the GT engine 10, the flow rate controller 152 outputs a control signal configured to instruct the fuel pump 20 to start reducing an amount of fuel supply to the GT engine 10 (Step S101). For example, the flow rate controller 152 notifies the fuel pump 20 of a reduction in the fuel flow rate per unit time using a control signal. After that, the fuel pump 20 continuously reduces an amount of discharge of the fuel flow rate so that the flow rate corresponding to the amount of reduction decreases per unit time.

Subsequently, the flow rate controller 152 compares a current fuel flow rate Wf with the misfire line (Step S102) and determines whether the current fuel flow rate Wf has reached the misfire line (Step S103). Here, when it is determined that the current fuel flow rate Wf has not reached the misfire line, the flow rate controller 152 returns to the process of Step S102 and determines again whether the fuel flow rate Wf has reached the misfire line. On the other hand, when it is determined in Step S103 that the current fuel flow rate Wf has reached the misfire line, the flow rate controller 152 controls the fuel pump 20 so that the fuel pump 20 stops the reduction in the fuel flow rate started in Step S101 and keeps the fuel flow rate constant (Step S104).

Subsequently, the drive controller 153 starts deceleration assist using the motor 31 (Step S105). After the start of the deceleration assist, the drive controller 153 compares a current temperature Te of the engine with the overtemperature line (Step S106) and determines whether the current temperature Te of the engine has reached the overtemperature line (Step S107). Here, when it is determined that the current temperature Te of the engine has not reached the overtemperature line, the drive controller 153 returns the process of the Step S106 and determines again whether the temperature Te of the engine has reached the overtemperature line. On the other hand, when it is determined in Step S107 that the current temperature Te of the engine has reached the overtemperature line, the drive controller 153 controls the load torque output by the motor 31 so that the temperature Te of the engine is along the overtemperature line (Step S108).

Subsequently, the drive controller 153 determines whether the condition for terminating the deceleration of the GT engine 10 (termination condition) is satisfied (Step S109). The termination condition may be determined based on any criterion in which the deceleration of the GT engine 10 needs to be terminated. For example, the termination condition may be that the number of rotations of the engine has reached the prescribed number of rotations, that a termination instruction of the engine deceleration has been input, that a prescribed time has elapsed from the start of deceleration, or other conditions other than these conditions. When it is determined that the termination condition is not satisfied, the drive controller 153 performs Step S109 again. In addition, when it is determined that the termination condition is satisfied, the drive controller 153 terminates a series of processes.

In the flow of FIG. 5, the process of performing the reduction in the fuel flow rate (Steps S101 to S104) is terminated and then the control of the load torque (Steps S105 to S108) is performed. Thus, the deceleration of the engine is performed only by controlling the load torque until the termination condition is satisfied. However, the control of the load torque is also likely to make the fuel flow rate away from the misfire line. For this reason, when it is determined in Step S109 that the termination condition is not satisfied and the fuel flow rate at that time has not reached the misfire line, the control device 100 may be constituted to start the reduction in the fuel flow rate again and then return the process to the process of Step S102.

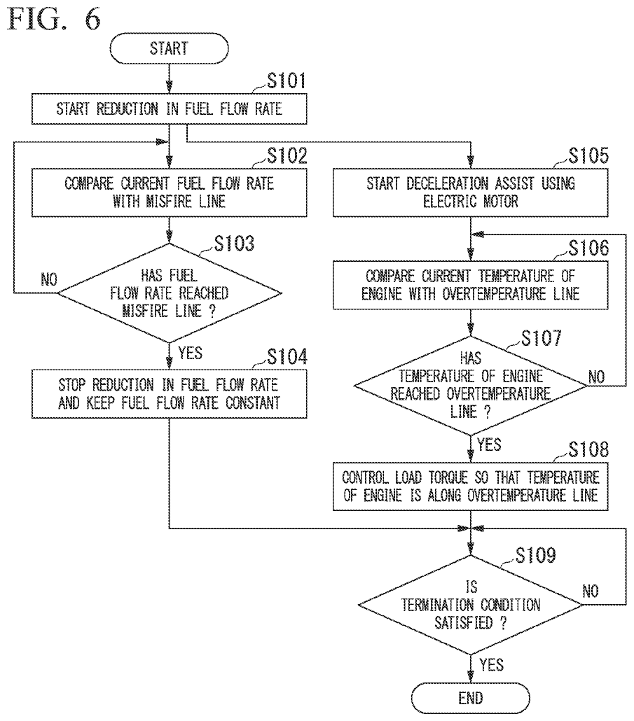

Although the process of performing the reduction in the fuel flow rate (Steps S101 to S104) is terminated and the control of the load torque (Steps S105 to S108) is performed in the flow of FIG. 5, as shown in FIG. 6, the control device 100 may be constituted to perform the process of performing the reduction in the fuel flow rate (Steps S101 to S104) and the control of the load torque (Steps S105 to S108) in parallel. Also in this case, as in the case of FIG. 5, when it is determined in Step S109 that the termination condition is not satisfied and the fuel flow rate at that time has not reached the misfire line, the control device 100 may be constituted to start the reduction in the fuel flow rate again and then return the process to the process of Step S102.

The aircraft propulsion system 1 according to the embodiment constituted in this way includes the flow rate controller 152 configured to reduce the flow rate of the fuel supplied to the GT engine 10 so that the GT engine 10 does not misfire and the drive controller 153 configured to control the magnitude of the load torque output by the motor 31 so that the temperature of the GT engine 10 does not exceed an allowable temperature to rapidly reduce the output of the GT engine 10 while preventing the misfire of the GT engine 10 when promoting a decrease in the output of the GT engine 10 by applying a load torque to the engine torque output by the GT engine 10 using the motor 31 included in the generator 30.

While the embodiments for carrying out the present invention have been described above using the embodiments, the present invention is not limited to these embodiments and various modifications and substitutions are possible without departing from the gist of the present invention. For example, the deceleration assist may be realized by applying a load torque to the GT engine 10 using the motor 31 and may be realized by applying a power generation load of the generator 30 to the GT engine 10 as a load torque (that is, driving the generator 30 using the GT engine 10).

What is claimed is:

1. An aircraft propulsion system, comprising:
a gas turbine engine attached to an airframe of an aircraft;
a generator connected to an engine shaft of the gas turbine engine;
a first electric motor driven using electric power including electric power generated by the generator;
a rotor attached to the airframe of the aircraft and driven using a driving force output by the first electric motor; and
a control device configured to control an operating state of the gas turbine engine,
wherein the control device includes
a storage device configured to store a program, and
a hardware processor, and
the hardware processor, by executing the program stored in the storage device,
performs flow rate control processing which reduces a flow rate of fuel supplied to the gas turbine engine so that the gas turbine engine does not misfire when a decrease in output of the gas turbine engine is promoted using a driving force output by a second electric motor included in the generator, and
performs drive control processing which controls a magnitude of the driving force output by the second electric motor so that a temperature of the gas turbine engine does not exceed an allowable temperature when the driving force output by the second electric motor promotes a decrease in output of the gas turbine engine.

2. The aircraft propulsion system according to claim 1, wherein the hardware processor stops a reduction in flow rate of the fuel and keeps a flow rate of the fuel constant when the flow rate of the fuel has reached a misfire line indicating a lower limit of a flow rate range in which the gas turbine engine does not misfire in the flow rate control processing.

3. The aircraft propulsion system according to claim 1, wherein the hardware processor controls a magnitude of the driving force output by the second electric motor so that the temperature of the gas turbine engine is along an overtemperature line when the temperature of the gas turbine engine has reached the overtemperature line indicating an upper limit of a temperature range in which the gas turbine engine is not in an overtemperature state in the drive control processing.

4. The aircraft propulsion system according to claim 1, wherein the hardware processor controls a magnitude of the driving force output by the second electric motor so that the temperature of the gas turbine engine is a temperature within a range from an overtemperature line to a lower limit temperature line indicating a temperature lower than the overtemperature line by a prescribed temperature when the temperature of the gas turbine engine has reached the overtemperature line indicating an upper limit of a temperature range in which the gas turbine engine is not in an overtemperature state in the drive control processing.

5. The aircraft propulsion system according to claim 1, wherein the hardware processor operates the flow rate control processing and the drive control processing in parallel when promoting a decrease in output of the gas turbine engine using the driving force output by the second electric motor.
